(19) United States
(12) Patent Application Publication
(10) Pub. No.: US 2015/0287336 A1
(43) Pub. Date: Oct. 8, 2015

(54) AUTOMATED PHISHING-EMAIL TRAINING

(71) Applicant: Bank of America Corporation, Charlotte, NC (US)

(72) Inventor: Jamison W. Scheeres, Charlotte, NC (US)

(73) Assignee: Bank of America Corporation, Charlotte, NC (US)

(21) Appl. No.: 14/244,957

(22) Filed: Apr. 4, 2014

(51) Int. Cl. G09B 19/00; G09B 5/02

(52) U.S. Cl. CPC G09B 19/00; G09B 5/02

(57) ABSTRACT

A computing platform may generate a message comprising instructions for handling phishing emails. The computing platform may communicate the message comprising instructions for handling phishing emails to a user device. The computing platform may generate a training email comprising phishing content. The computing platform may communicate the training email comprising phishing content to the user device. The computing platform may determine whether the training email comprising phishing content has been handled in accordance with the instructions for handling phishing emails. The computing platform may generate, based on whether the training email comprising phishing content has been handled in accordance with the instructions for handling phishing emails, a new training email comprising different phishing content.

### BACKGROUND

Phishing is the act of impersonating a trustworthy source in an attempt to acquire sensitive, personal, or confidential information, or the like. A common form of phishing is implemented using emails that are designed to appear to be from a known, legitimate, or otherwise trustworthy source, and request a user to provide sensitive, personal, or confidential information, or the like, and/or contain links to websites designed to collect such information. While some phishing emails are easy to identify, others may more closely resemble legitimate requests or solicitations, and/or may contain persuasive pretexts (e.g., appeals to sympathy, promising opportunities, or the like), and may thus pose a serious threat to users and/or organizations. As the phishing-email threat grows, many organizations are taking steps to train their employees to recognize and report emails that they suspect may be phishing emails. Accordingly, a need exists for automated phishing-email training.

### SUMMARY

The following presents a simplified summary in order to provide a basic understanding of some aspects of the disclosure. This summary is not an extensive overview of the disclosure. It is intended neither to identify key or critical elements of the disclosure nor to delineate the scope of the disclosure. The following summary merely presents some concepts of the disclosure in a simplified form as a prelude to the description below.

In accordance with one or more embodiments, a computing platform may generate a message comprising instructions for handling phishing emails. The computing platform may communicate the message comprising instructions for handling phishing emails to a user device. The computing platform may generate a training email comprising phishing content. The computing platform may communicate the training email comprising phishing content to the user device. The computing platform may determine whether the training email comprising phishing content has been handled in accordance with the instructions for handling phishing emails. The computing platform may generate, based on whether the training email comprising phishing content has been handled in accordance with the instructions for handling phishing emails, a new training email comprising different phishing content.

In some embodiments, determining whether the training email comprising phishing content has been handled in accordance with the instructions for handling phishing emails may include determining that the training email comprising phishing content has been handled in accordance with the instructions for handling phishing emails. In such embodiments, generating the new training email comprising different phishing content may include generating a new training email that comprises phishing content that includes an equal or smaller number of phishing characteristics than the training email comprising phishing content. In some embodiments, generating the new training email that comprises phishing content that includes an equal or smaller number of phishing characteristics than the training email comprising phishing content may include generating a new training email that comprises phishing content that includes a number of phishing characteristics equal to a number of phishing characteristics included in the training email. In some embodiments, generating the new training email that comprises phishing content that includes an equal or smaller number of phishing characteristics than the training email comprising phishing content may include generating a new training email that comprises phishing content that includes a smaller number of phishing characteristics than the training email.

In some embodiments, determining whether the training email comprising phishing content has been handled in accordance with the instructions for handling phishing emails may include determining that the training email comprising phishing content has not been handled in accordance with the instructions for handling phishing emails. In such embodiments, generating the new training email comprising different phishing content may include generating a new training email that comprises phishing content that includes an equal or greater number of phishing characteristics than the training email comprising phishing content. In some embodiments, generating the new training email that comprises phishing content that includes an equal or greater number of phishing characteristics than the training email comprising phishing content may include generating a new training email that comprises phishing content that includes a number of phishing characteristics equal to a number of phishing characteristics included in the training email. In some embodiments, generating the new training email that comprises phishing content that includes an equal or greater number of phishing characteristics than the training email comprising phishing content may include generating a new training email that comprises phishing content that includes a greater number of phishing characteristics than the training email.

In some embodiments, generating the message comprising instructions for handling phishing emails may include generating a message comprising instructions for identifying a phishing email and instructions to not invoke links contained in a phishing email.

In some embodiments, the training email comprising phishing content may include one or more links. In such embodiments, determining whether the training email comprising phishing content has been handled in accordance with the instructions for handling phishing emails may include determining that the training email comprising phishing content has been handled in accordance with the instructions for handling phishing emails, and determining that the training email comprising phishing content has been handled in accordance with the instructions for handling phishing emails may include determining that the one or more links have not been invoked. Alternatively, in such embodiments, determining whether the training email comprising phishing content has been handled in accordance with the instructions for handling phishing emails may include determining that the training email comprising phishing content has not been handled in accordance with the instructions for handling phishing emails, and determining that the training email comprising phishing content has not been handled in accordance with the instructions for handling phishing emails may include determining that at least one of the one or more links has been invoked. In some embodiments, responsive to determining that the at least one of the one or more links has been invoked, the computing platform may generate a message indicating that the training email comprising phishing content has not been handled in accordance with the instructions for handling phishing emails, comprising a depiction of the training email comprising phishing content that identifies one or more phishing characteristics of the training email comprising phishing content, and indicating that the one or more links should not have been invoked. The computing platform may communicate the message indicating that the training email comprising phishing content has not been handled in accordance with the instructions for handling phishing emails to the user device.

In some embodiments, generating the message comprising instructions for handling phishing emails may include generating a message comprising instructions for identifying a phishing email and instructions to forward a phishing email to a specified email address. In such embodiments, determining whether the training email comprising phishing content has been handled in accordance with the instructions for handling phishing emails may include determining that the training email comprising phishing content has been handled in accordance with the instructions for handling phishing emails, and determining that the training email comprising phishing content has been handled in accordance with the instructions for handling phishing emails may include determining that the training email comprising phishing content has been forwarded to the specified email address. Alternatively, in such embodiments, determining whether the training email comprising phishing content has been handled in accordance with the instructions for handling phishing emails may include determining that the training email comprising phishing content has not been handled in accordance with the instructions for handling phishing emails, and determining that the training email comprising phishing content has not been handled in accordance with the instructions for handling phishing emails may include determining that the training email comprising phishing content has not been forwarded to the specified email address. In some embodiments, responsive to determining that the training email comprising phishing content has not been forwarded to the specified email address, the computing platform may generate a message indicating that the training email comprising phishing content has not been handled in accordance with the instructions for handling phishing emails, comprising a depiction of the training email comprising phishing content that identifies one or more phishing characteristics of the training email comprising phishing content, and indicating that the training email comprising phishing content should have been forwarded to the specified email address. The computing platform may communicate the message indicating that the training email comprising phishing content has not been handled in accordance with the instructions for handling phishing emails to the user device.

In some embodiments, the computing platform may communicate the message comprising instructions for handling phishing emails to a different user device. The computing platform may generate another training email comprising phishing content. The computing platform may communicate the another training email comprising phishing content to the different user device. The computing platform may determine whether the another training email comprising phishing content has been handled in accordance with the instructions for handling phishing emails. The computing platform may generate, based on whether the another training email comprising phishing content has been handled in accordance with the instructions for handling phishing emails, a different new training email comprising different phishing content. The computing platform may communicate the different new training email comprising different phishing content to the different user device.

In some embodiments, the computing platform may determine whether the new training email comprising different phishing content has been handled in accordance with the instructions for handling phishing emails, and/or whether the different new training email comprising different phishing content has been handled in accordance with the instructions for handling phishing emails. In some embodiments, the computing platform may generate a record for a user associated with the user device. The record for the user associated with the user device may include information indicating whether the training email comprising phishing content has been handled in accordance with the instructions for handling phishing emails and/or whether the new training email comprising different phishing content has been handled in accordance with the instructions for handling phishing emails. Additionally or alternatively, the computing platform may generate a record for a user associated with the different user device. The record for the user associated with the different user device may include information indicating whether the another training email comprising phishing content has been handled in accordance with the instructions for handling phishing emails and/or whether the different new training email comprising different phishing content has been handled in accordance with the instructions for handling phishing emails. In some embodiments, the computing platform may store the record for the user associated with the user device and/or the record for the user associated with the different user device.

In some embodiments, the computing platform may utilize the information indicating whether the training email comprising phishing content has been handled in accordance with the instructions for handling phishing emails and/or whether the new training email comprising different phishing content has been handled in accordance with the instructions for handling phishing emails, and/or the information indicating whether the another training email comprising phishing content has been handled in accordance with the instructions for handling phishing emails and/or whether the different new training email comprising different phishing content has been handled in accordance with the instructions for handling phishing emails, to generate a report indicating whether the training email comprising phishing content has been handled in accordance with the instructions for handling phishing emails, whether the new training email comprising different phishing content has been handled in accordance with the instructions for handling phishing emails, whether the another training email comprising phishing content has been handled in accordance with the instructions for handling phishing emails, and/or whether the different new training email comprising different phishing content has been handled in accordance with the instructions for handling phishing emails. In some embodiments, the computing platform may communicate the report to a user device associated with an administrator of the computing platform.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for automated phishing-email training in accordance with one or more example embodiments;

FIGS. 4A, 4B, 4C, 4D, 4E, and 4F depict an illustrative event sequence for automated phishing-email training in accordance with one or more example embodiments;

FIG. 5 depicts an example training message for automated phishing-email training in accordance with one or more example embodiments;

FIG. 6 depicts an example automated phishing-email training report in accordance with one or more example embodiments; and

FIG. 7 depicts an illustrative method for automated phishing-email training in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

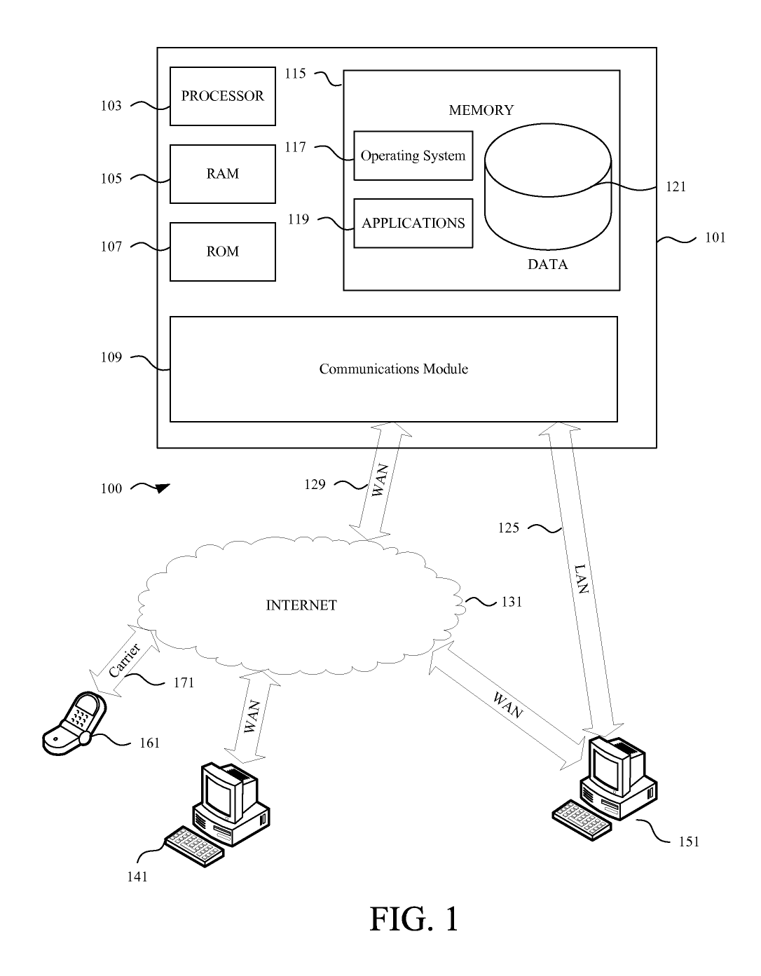

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

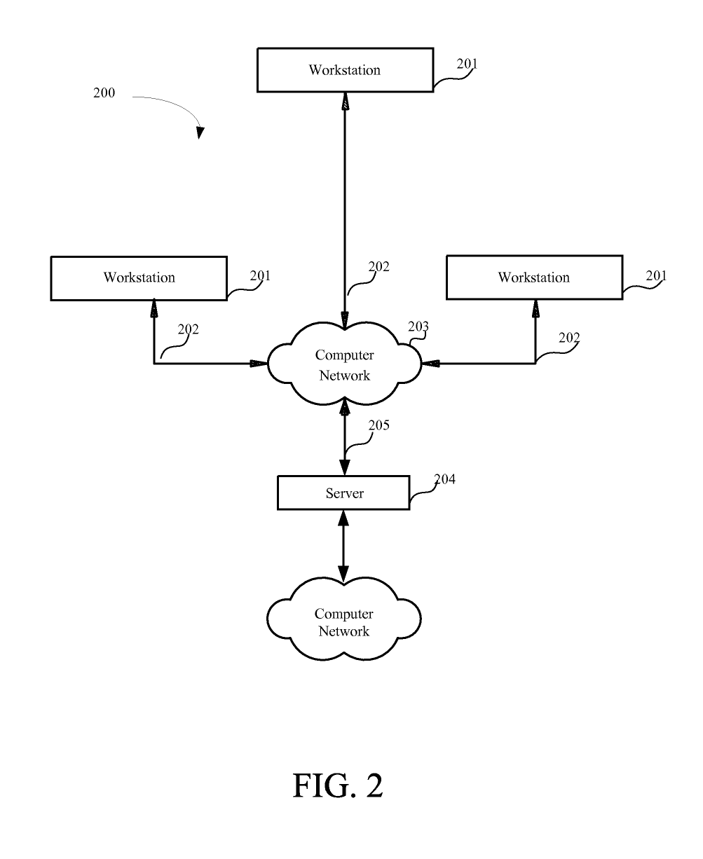

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

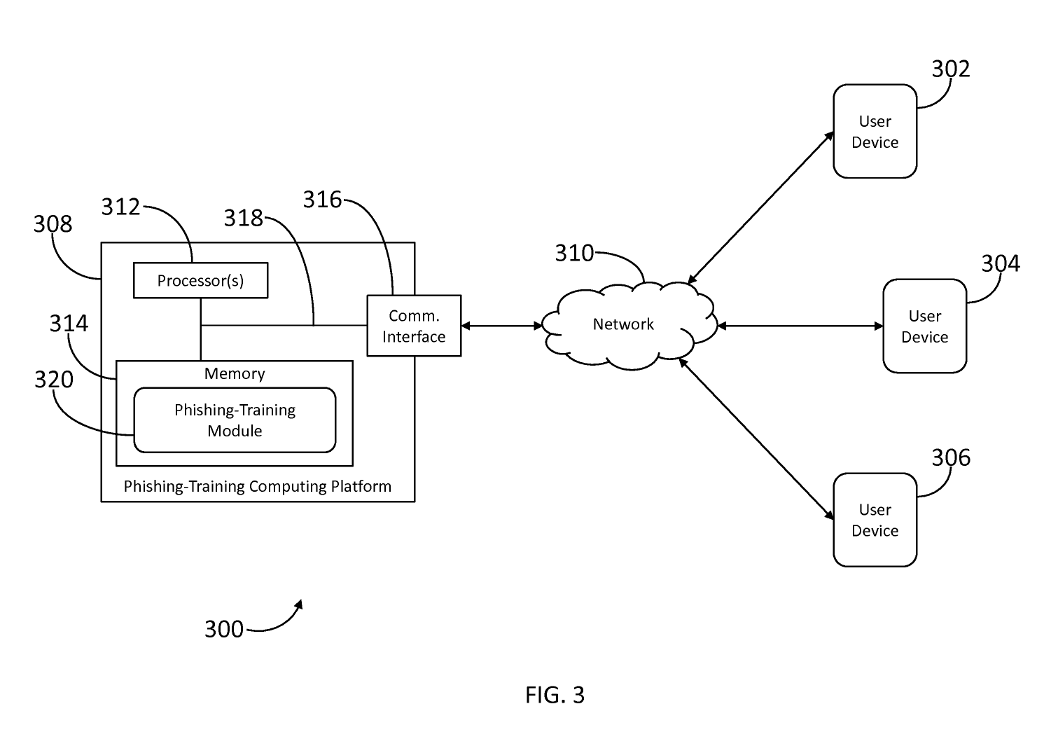

FIG. 3 depicts an illustrative computing environment for automated phishing-email training in accordance with one or more example embodiments. Referring to FIG. 3, computing environment 300 may include one or more computing devices. For example, computing environment 300 may include user device 302, user device 304, and user device 306. User device 302, user device 304, and/or user device 306 may be any type of computing device. For example, user device 302, user device 304, and/or user device 306 may be a desktop computer, laptop computer, tablet computer, smart phone, or the like. Computing environment 300 may also include one or more computing platforms. For example, computing environment 300 may include computing platform 308. Computing platform 308 may include one or more computing devices configured to perform one or more of the functions described herein. For example, computing platform 308 may include one or more computers (e.g., laptop computers, desktop computers, servers, server blades, or the like). Computing environment 300 may also include one or more networks, which may interconnect one or more of user device 302, user device 304, user device 306, and/or computing platform 308. For example, computing environment 300 may include network 310. Network 310 may include one or more sub-networks (e.g., LANs, WANs, or the like).

Computing platform 308 may include one or more processor(s) 312, memory 314, communication interface 316, and data bus 318. Data bus 318 may interconnect processor(s) 312, memory 314, and/or communication interface 316. Communication interface 316 may be a network interface configured to support communication between computing platform 308 and network 310, or one or more sub-networks thereof. Memory 314 may include one or more program modules comprising instructions that when executed by processor(s) 312 cause computing platform 308 to perform one or more functions described herein. For example, memory 314 may include phishing-training module 320, which may comprise instructions that when executed by processor(s) 312 may cause computing platform 308 to perform one or more functions described herein.

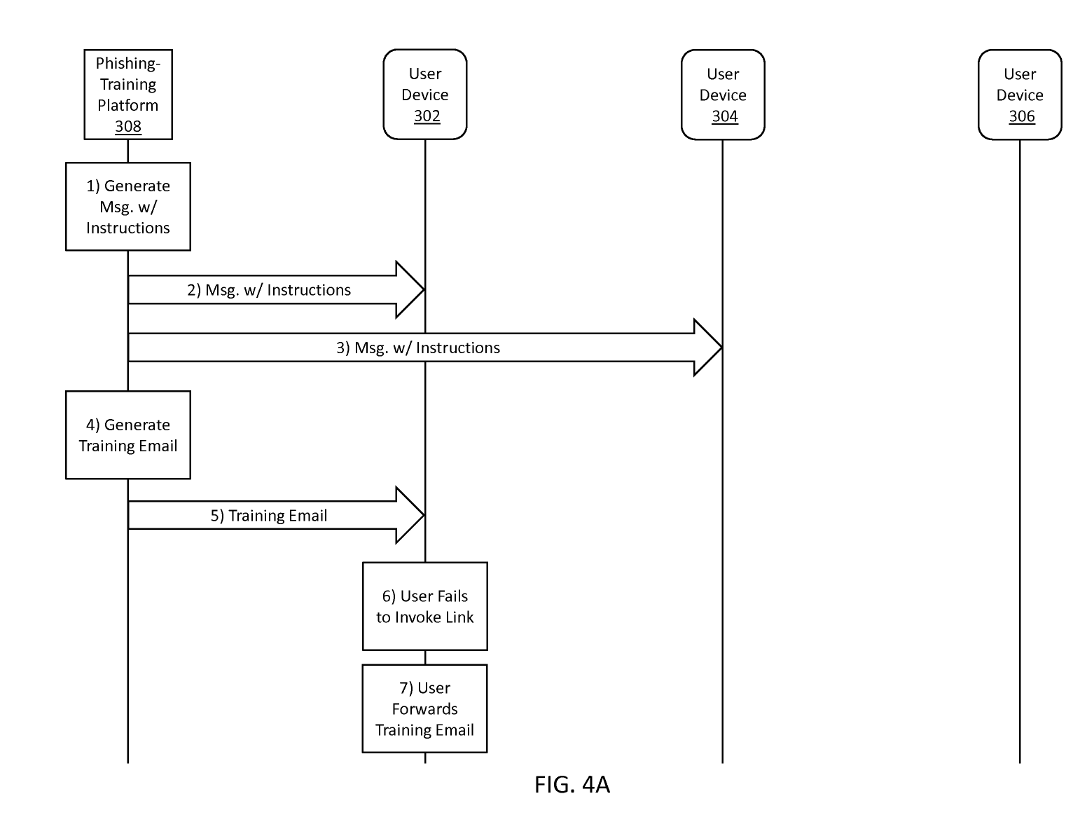

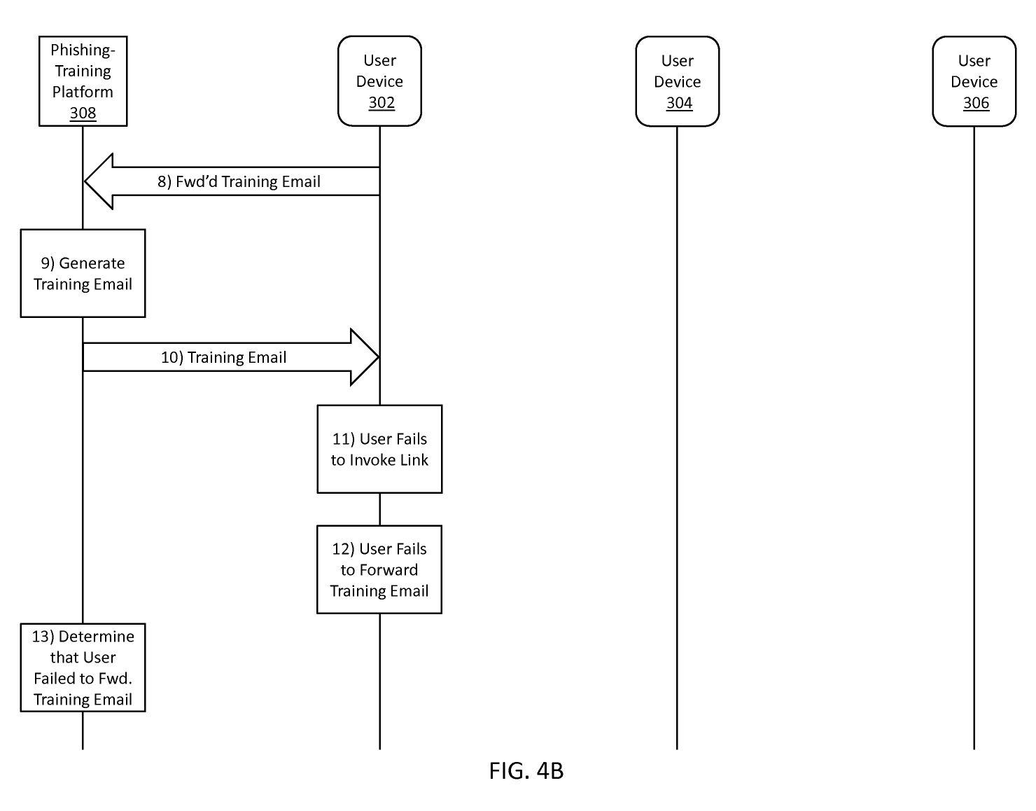

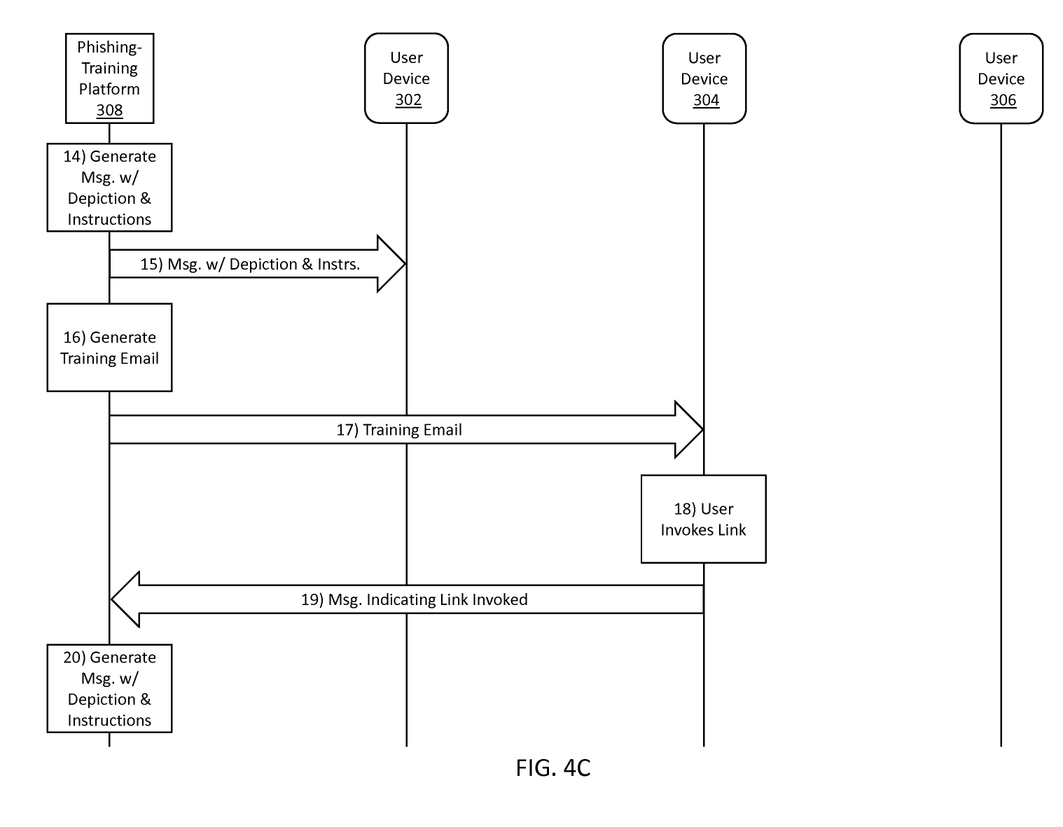

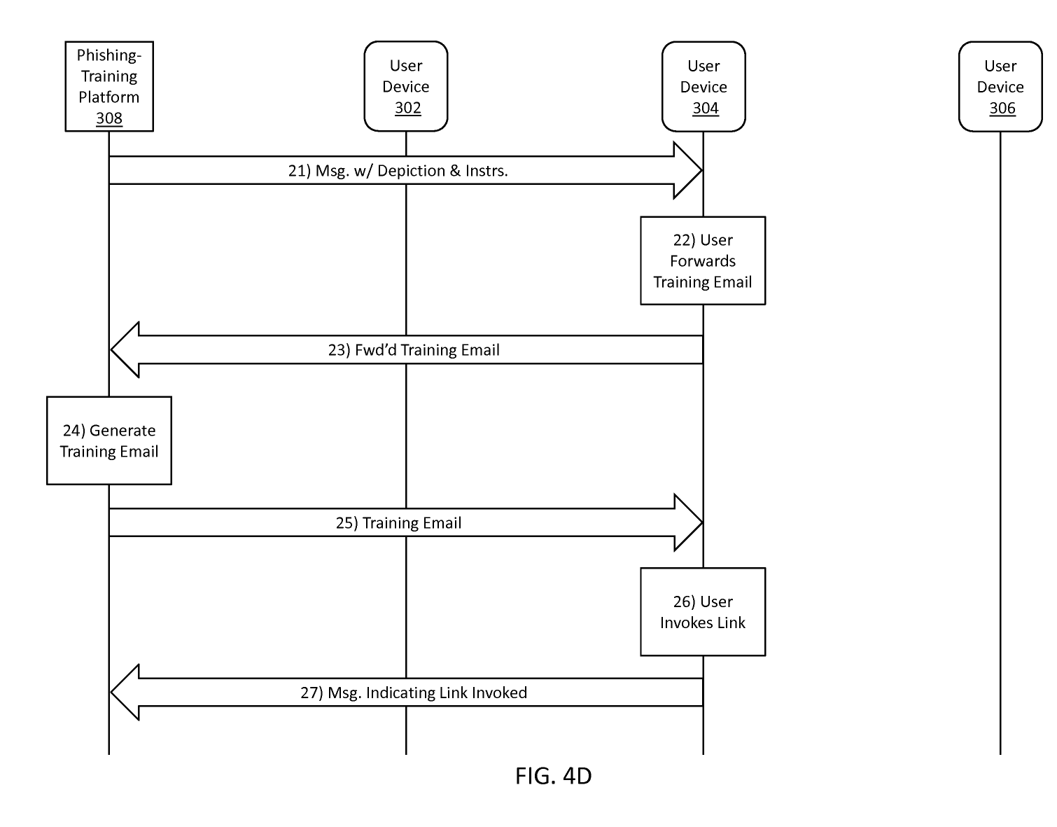

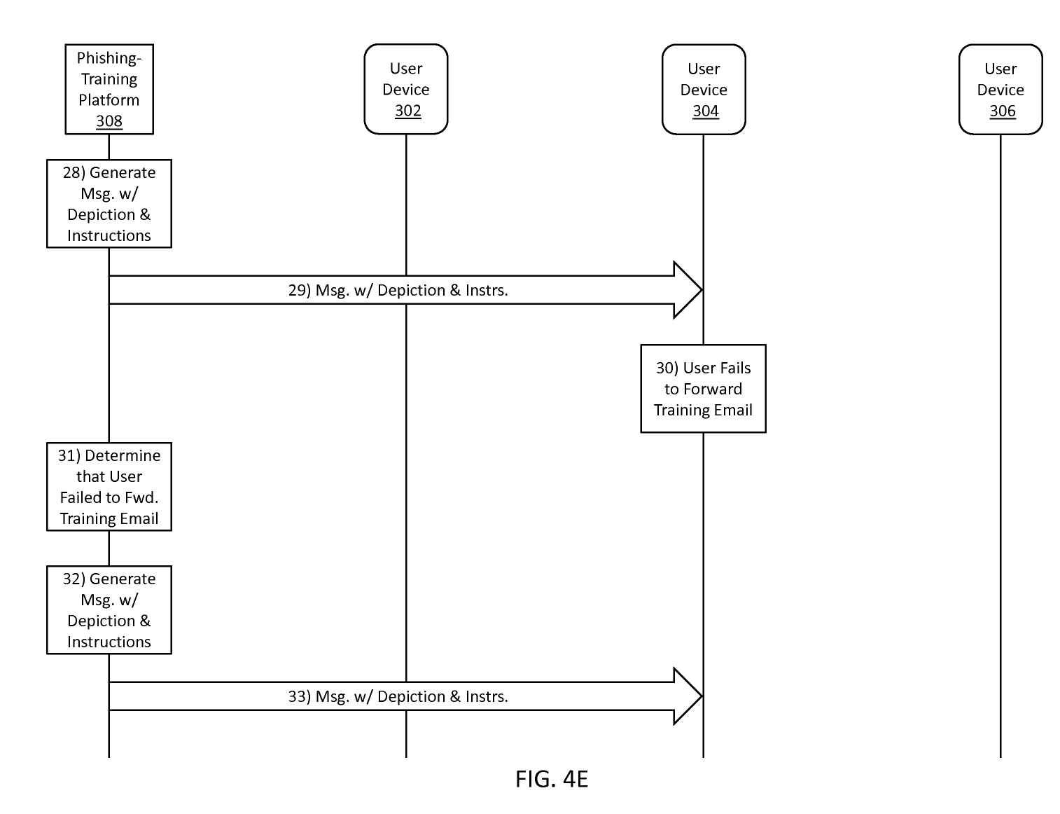

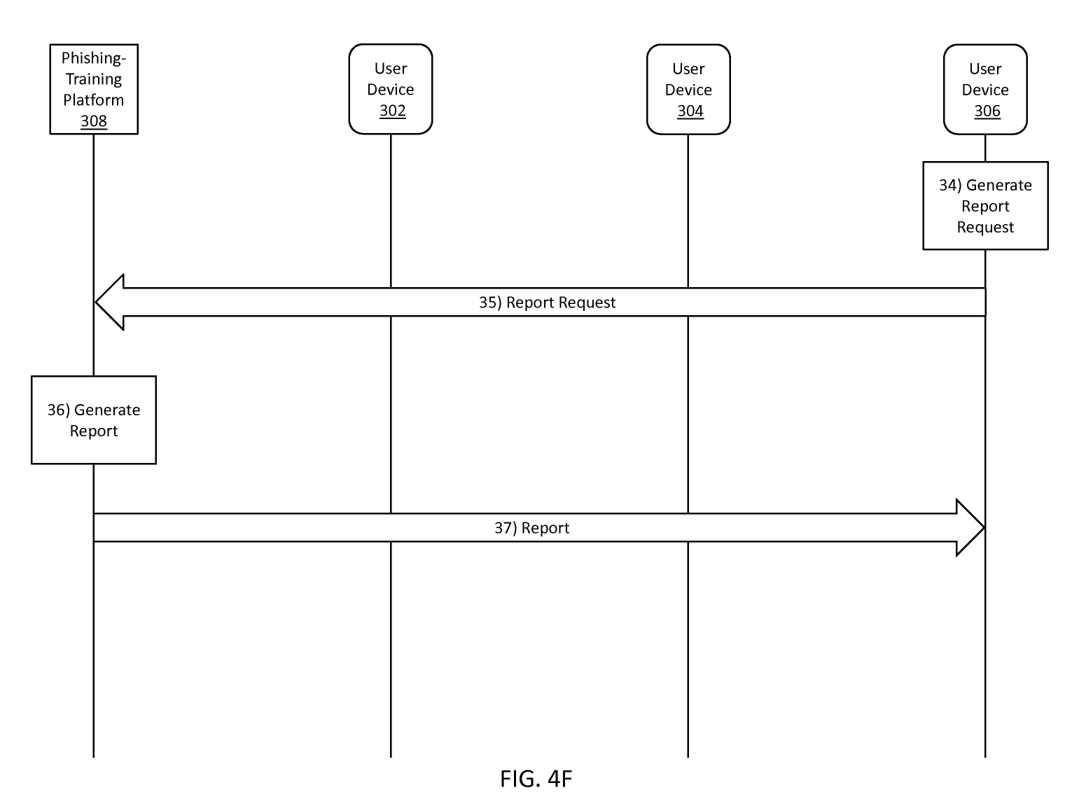

FIGS. 4A, 4B, 4C, 4D, 4E, and 4F depict an illustrative event sequence for automated phishing-email training in accordance with one or more example embodiments. Referring to FIG. 4A, at step 1, computing platform 308 may generate a message comprising instructions for handling phishing emails. For example, computing platform 308 may generate a message that includes instructions for identifying phishing emails, and/or that instructs users not to invoke links contained in emails that are suspected to be phishing emails and/or to forward suspected phishing emails to a specified email address. At step 2, computing platform 308 may communicate (e.g., via communication interface 316) the message comprising instructions for handling phishing emails to user device 302. Similarly, at step 3, computing platform 308 may communicate (e.g., via communication interface 316) the message comprising instructions for handling phishing emails to user device 304. At step 4, computing platform 308 may generate a training email comprising phishing content. For example, computing platform 308 may generate an email designed to resemble an actual phishing email, but intended for training purposes. As will be described in greater detail below, the training email may include phishing content that includes a number of phishing characteristics (e.g., an unknown or suspicious sender address, a subject line that includes a classic phishing pretext (e.g., an emotional appeal, a solicitation for money and/or personal, confidential, or sensitive information, a job offer or other promising opportunity, or the like), body content that includes a classic phishing pretext, one or more suspicious links, one or more suspicious graphic elements, or the like). At step 5, computing platform 308 may communicate (e.g., via communication interface 316) the training email comprising phishing content to user device 302. At step 6, a user of user device 302 may receive the training email comprising phishing content and may act in accordance with the previously communicated instructions for handling phishing emails, for example, by failing to invoke one or more links contained in the training email comprising phishing content. Similarly, at step 7, a user of user device 302 may act in accordance with the previously communicated instructions for handling phishing emails, for example, by forwarding the training email comprising phishing content to an email address specified by the previously communicated instructions for handling phishing emails. Referring to FIG. 4B, at step 8, user device 302 may communicate the training email comprising phishing content to computing platform 308 (e.g., by, as described above, forwarding the training email comprising phishing content to the email address specified by the previously communicated instructions for handling phishing emails). In some embodiments, computing platform 308 may generate and/or update one or more records associated with the user of user device 302 to include information indicating whether the training email comprising phishing content has been handled in accordance with the instructions for handling phishing emails (e.g., to indicate that the link(s) included in the training email comprising phishing content were not invoked by the user of user device 302 and/or to indicate that the user of user device 302 forwarded the training email comprising phishing content to the email address specified by the instructions for handling phishing emails), and may store the record(s) in memory 314.

At step 9, computing platform 308 may determine whether the training email comprising phishing content has been handled in accordance with the instructions for handling phishing emails, and may generate, based on whether the training email comprising phishing content has been handled in accordance with the instructions for handling phishing emails, a new training email comprising different phishing content. For example, computing platform 308 may determine that the training email comprising phishing content (e.g., the training email generated in step 4 above) has been handled in accordance with the instructions for handling phishing emails (e.g., the user of user device 302 failed to invoke the one or more links included in the training email comprising phishing content and the user of user device 302 forwarded the training email comprising phishing content to the email address specified by the previously communicated instructions for handling phishing emails). In some embodiments, responsive to determining that the training email has been handled in accordance with the instructions for handling phishing emails, computing platform 308 may generate a new training email that comprises phishing content that includes an equal or smaller number of phishing characteristics than the previously generated training email comprising phishing content (e.g., the training email generated in step 4 above). For example, computing platform 308 may generate a new training email comprising different phishing content that includes an equal or smaller number of phishing characteristics than the previously generated training email comprising phishing content (e.g., an email that is equally easy or more difficult to identify as a phishing email). In some embodiments, computing platform 308 may be configured to generate training emails comprising phishing content at multiple levels of difficulty (e.g., including various numbers of phishing characteristics), and/or may be configured to generate multiple different emails at each level of difficulty. At step 10, computing platform 308 may communicate (e.g., via communication interface 316) the new training email comprising different phishing content to user device 302.

At step 11, a user of user device 302 may receive the new training email comprising different phishing content and may act in accordance with the previously communicated instructions for handling phishing emails, for example, by failing to invoke one or more links contained in the training email comprising phishing content. At step 12, however, the user of user device 302 may fail to act in accordance with the previously communicated instructions for handling phishing emails by failing to forward the new training email comprising different phishing content to the email address specified by the previously communicated instructions for handling phishing emails. At step 13, computing platform 308 may determine that the new training email comprising different phishing content has not been handled in accordance with the instructions for handling phishing emails, for example, by determining that the new training email comprising different phishing content has not been forwarded to the email address specified by the instructions for handling phishing emails (e.g., after a defined period of time has lapsed). In some embodiments, computing platform 308 may generate and/or update one or more records associated with the user of user device 302 to include information indicating whether the new training email comprising different phishing content has been handled in accordance with the instructions for handling phishing emails (e.g., to indicate that the link(s) included in the new training email comprising different phishing content were not invoked by the user of user device 302 and/or to indicate that the user of user device 302 failed to forward the new training email comprising different phishing content to the email address specified by the instructions for handling phishing emails), and may store the record(s) in memory 314.

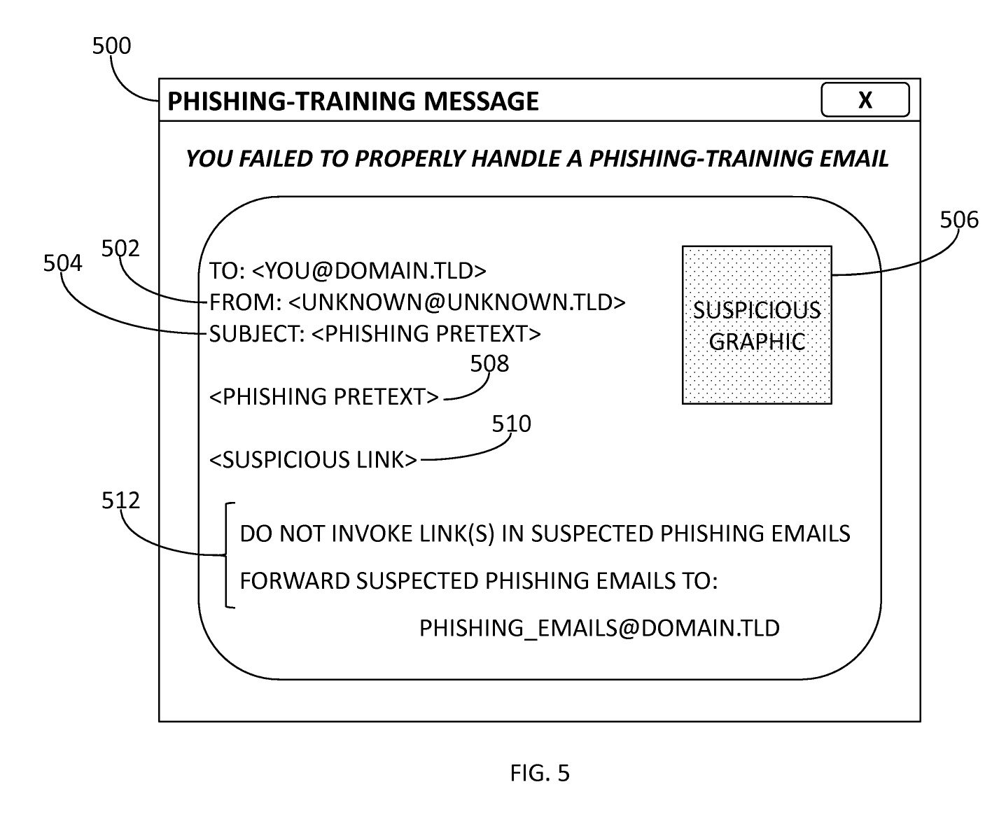

Referring to FIG. 4C, at step 14, computing platform 308 may generate a message indicating that the training email comprising phishing content (e.g., the new training email comprising the different phishing content generated in step 9 above) has not been handled in accordance with the instructions for handling phishing emails. For example, FIG. 5 depicts an example training message for automated phishing-email training in accordance with one or more example embodiments. Referring to FIG. 5, message 500 may include a depiction of the training email comprising phishing content that identifies one or more phishing characteristics of the training email comprising phishing content (e.g., unknown or suspicious sender address 502, subject line 504 that includes a classic phishing pretext, one or more suspicious graphic elements 506, body content that includes classic phishing pretext 508, one or more suspicious links 510, or the like), and may include instructions 512, indicating that links contained in suspected phishing emails should not be invoked and/or that suspected phishing emails (e.g., the training email comprising phishing content) should be (or should have been) forwarded to a specified email address. Returning to FIG. 4C, at step 15, computing platform 308 may communicate the message indicating that the training email comprising phishing content has not been handled in accordance with the instructions for handling phishing emails (e.g., message 500) to user device 302.

At step 16, computing platform 308 may generate a training email comprising phishing content. For example, computing platform 308 may generate an email designed to resemble an actual phishing email, but intended for training purposes. As indicated above, the training email may include phishing content that includes a number of phishing characteristics (e.g., an unknown or suspicious sender address, a subject line that includes a classic phishing pretext (e.g., an emotional appeal, a solicitation for money and/or personal, confidential, or sensitive information, a job offer or other promising opportunity, or the like), body content that includes a classic phishing pretext, one or more suspicious links, one or more suspicious graphic elements, or the like). At step 17, computing platform 308 may communicate (e.g., via communication interface 316) the training email comprising phishing content to user device 304. At step 18, a user of user device 304 may receive the training email comprising phishing content, and may fail to act in accordance with the previously communicated instructions for handling phishing emails by invoking one or more links contained in the training email comprising phishing content. At step 19, responsive to the user of user device 304 invoking the one or more links contained in the training email comprising phishing content, user device 304 may communicate a message indicating that the link(s) contained in the training email comprising phishing content have been invoked to computing platform 308. Computing platform 308 may receive (e.g., via communication interface 316) the message indicating that the link(s) contained in the training email comprising phishing content have been invoked, and may determine (e.g., based on the message indicating that the link(s) have been invoked) that the training email comprising phishing content has not been handled in accordance with the previously communicated instructions for handling phishing emails. In some embodiments, computing platform 308 may generate and/or update one or more records associated with the user of user device 304 to include information indicating whether the training email comprising phishing content has been handled in accordance with the instructions for handling phishing emails (e.g., to indicate that the link(s) included in the training email comprising phishing content were invoked by the user of user device 304), and may store the record(s) in memory 314.

Responsive to determining that the training email comprising phishing content has not been handled in accordance with the previously communicated instructions for handling phishing emails, at step 20, computing platform 308 may generate a message indicating that the training email comprising phishing content has not been handled in accordance with the instructions for handling phishing emails, comprising a depiction of the training email comprising phishing content that identifies one or more phishing characteristics of the training email comprising phishing content, and indicating that the one or more links should not have been invoked. For example, the link(s) contained in the training email may be configured to cause user device 304 to display (e.g., navigate an application, such as a web browser, or the like, executing on user device 304) to a webpage, graphical user interface, or the like comprising message 500.

Referring to FIG. 4D, at step 21, computing platform 308 may communicate (e.g., via communication interface 316) the message indicating that the training email comprising phishing content has not been handled in accordance with the instructions for handling phishing emails to user device 304. At step 22, the user of user device 304 may receive the message indicating that the training email comprising phishing content has not been handled in accordance with the instructions for handling phishing emails, and may act in accordance with the instructions for handling phishing emails. For example, the user of user device 304 may forward the training email comprising phishing content to the email address specified by the instructions for handling phishing emails (e.g., by message 500). At step 23, user device 304 may communicate the training email comprising phishing content to computing platform 308 (e.g., by, as described above, forwarding the training email comprising phishing content to the email address specified by the previously communicated instructions for handling phishing emails). In some embodiments, computing platform 308 may generate and/or update one or more records associated with the user of user device 304 to include information indicating whether the training email comprising phishing content has been handled in accordance with the instructions for handling phishing emails (e.g., to indicate that the user of user device 304 forwarded the training email comprising phishing content to the email address specified by the instructions for handling phishing emails), and may store the record(s) in memory 314.

At step 24, computing platform 308 may determine whether the training email comprising phishing content (e.g., the training email generated in step 16 above) has been handled in accordance with the instructions for handling phishing emails, and may generate, based on whether the training email comprising phishing content has been handled in accordance with the instructions for handling phishing emails, a new training email comprising different phishing content. For example, computing platform 308 may determine that the training email comprising phishing content (e.g., the training email generated in step 16 above) has not been handled in accordance with the instructions for handling phishing emails (e.g., the user of user device 304 invoked the link(s) included in the training email comprising phishing content). In some embodiments, responsive to determining that the training email has not been handled in accordance with the instructions for handling phishing emails, computing platform 308 may generate a new training email that comprises phishing content that includes an equal or greater number of phishing characteristics than the previously generated training email comprising phishing content (e.g., the training email generated in step 16 above). For example, computing platform 308 may generate a new training email comprising different phishing content that includes an equal or greater number of phishing characteristics than the previously generated training email comprising phishing content (e.g., an email that is equally easy or less difficult to identify as a phishing email). At step 25, computing platform 308 may communicate (e.g., via communication interface 316) the new training email comprising different phishing content to user device 304.

At step 26, a user of user device 304 may receive the new training email comprising different phishing content, and may fail to act in accordance with the previously communicated instructions for handling phishing emails, for example, by invoking one or more links contained in the training email comprising phishing content. At step 27, responsive to the user of user device 304 invoking the one or more links contained in the new training email comprising different phishing content, user device 304 may communicate a message indicating that the link(s) contained in the new training email comprising phishing content have been invoked to computing platform 308. Computing platform 308 may receive (e.g., via communication interface 316) the message indicating that the link(s) contained in the new training email comprising different phishing content have been invoked, and may determine (e.g., based on the message indicating that the link(s) have been invoked) that the new training email comprising different phishing content has not been handled in accordance with the previously communicated instructions for handling phishing emails. In some embodiments, computing platform 308 may generate and/or update one or more records associated with the user of user device 304 to include information indicating whether the new training email comprising different phishing content has been handled in accordance with the instructions for handling phishing emails (e.g., to indicate that the link(s) included in the new training email comprising different phishing content were invoked by the user of user device 304), and may store the record(s) in memory 314.

Referring to FIG. 4E, responsive to determining that the new training email comprising different phishing content has not been handled in accordance with the previously communicated instructions for handling phishing emails, at step 28, computing platform 308 may generate a message indicating that the new training email comprising different phishing content has not been handled in accordance with the instructions for handling phishing emails, comprising a depiction of the new training email comprising different phishing content that identifies one or more phishing characteristics of the new training email comprising different phishing content, and indicating that the one or more links should not have been invoked. For example, the link(s) contained in the new training email may be configured to cause user device 304 to display (e.g., navigate an application, such as a web browser, or the like, executing on user device 304) to a webpage, graphical user interface, or the like comprising message 500. At step 29, computing platform 308 may communicate (e.g., via communication interface 316) the message indicating that the new training email comprising different phishing content has not been handled in accordance with the instructions for handling phishing emails to user device 304.

At step 30, the user of user device 304 may receive the message indicating that the training email comprising phishing content has not been handled in accordance with the instructions for handling phishing emails, and may fail to act in accordance with the instructions for handling phishing emails. For example, the user of user device 304 may fail to forward the new training email comprising different phishing content to the email address specified by the instructions for handling phishing emails (e.g., by message 500). At step 31, computing platform 308 may determine that the new training email comprising different phishing content has not been handled in accordance with the instructions for handling phishing emails, for example, by determining that the new training email comprising different phishing content has not been forwarded to the email address specified by the instructions for handling phishing emails (e.g., after a defined period of time has lapsed). In some embodiments, computing platform 308 may generate and/or update one or more records associated with the user of user device 304 to include information indicating whether the new training email comprising different phishing content has been handled in accordance with the instructions for handling phishing emails (e.g., to indicate that the user of user device 304 failed to forward the new training email comprising different phishing content to the email address specified by the instructions for handling phishing emails), and may store the record(s) in memory 314. At step 32, computing platform 308 may generate another message indicating that the new training email comprising different phishing content has not been handled in accordance with the instructions for handling phishing emails, comprising a depiction of the new training email comprising different phishing content that identifies one or more phishing characteristics of the new training email comprising different phishing content, and indicating that the new training email comprising phishing content should have been forward to the email address specified by the instructions for handling phishing emails (e.g., message 500). At step 33, computing platform 308 may communicate (e.g., via communication interface 316) the message indicating that the new training email comprising different phishing content has not been handled in accordance with the instructions for handling phishing emails to user device 304.

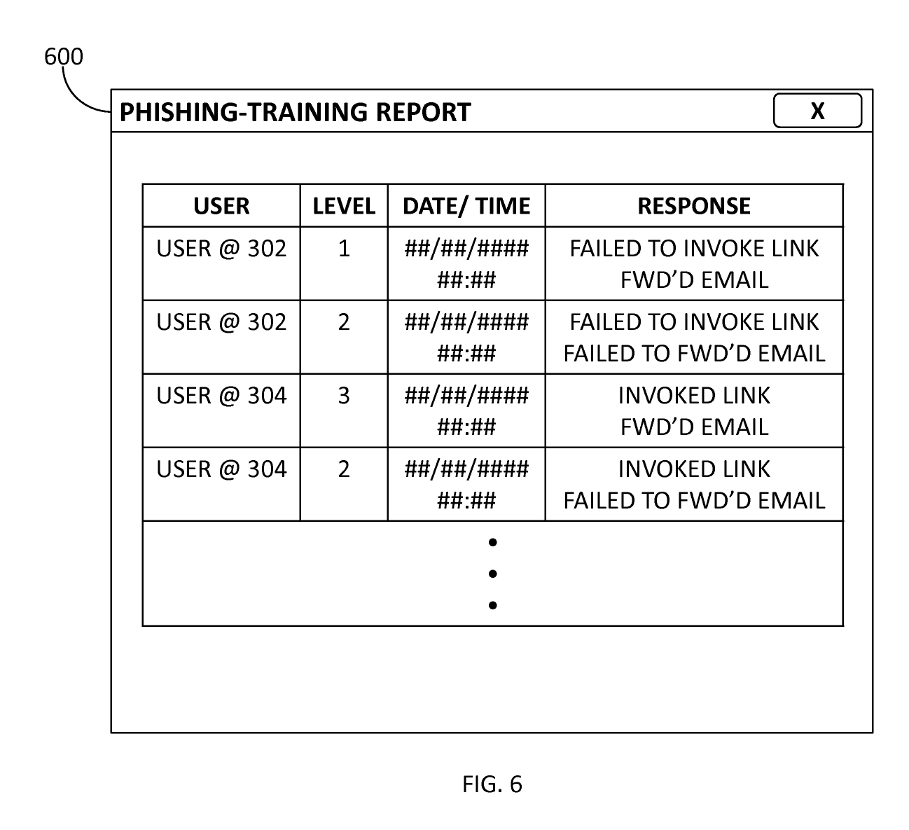

Referring to FIG. 4F, at step 34, user device 306 may generate a request for a phishing-training report. For example, an administrator of computing environment 300 may desire to see a report summarizing the status of phishing training for one or more users of computing environment 300 (e.g., the user of user device 302 and/or the user of user device 304), and may utilize user device 306 to generate a request for a phishing-training report. At step 35, user device 306 may communicate the request for the phishing-training report to computing platform 308, which may receive the request for the phishing-training report (e.g., via communication interface 316). At step 36, computing platform 308 may utilize information contained in one or more records (e.g., one or more records associated with the user of user device 302 and/or one or more records associated with the user of user device 304) to generate a report indicating whether one or more phishing training emails have been handled in accordance with the instructions for handling phishing emails. For example, FIG. 6 depicts an example automated phishing-email training report in accordance with one or more example embodiments. Referring to FIG. 6, report 600 may indicate whether one or more of the training emails generated by computing platform 308 have been handled in accordance with the instructions for handling phishing emails. For example, report 600 may indicate that the user of user device 302 failed to invoke link(s) contained in the training email generated in step 4 above and forwarded the training email generated in step 4 above to the email address specified by the instructions for handling phishing emails, that the user of user device 302 failed to invoke link(s) contained in the new training email generated in step 9 above and failed to forward the training email generated in step 9 above to the email address specified by the instructions for handling phishing emails, that the user of user device 304 invoked link(s) contained in the training email generated in step 16 above and forwarded the training email generated in step 16 above to the email address specified by the instructions for handling phishing emails, and/or that the user of user device 304 invoked link(s) contained in the new training email generated in step 24 above and failed to forward the new training email generated in step 24 above to the email address specified by the instructions for handling phishing emails. In some embodiments, report 600 may include one or more relevant date/time stamps (e.g., data/time stamps corresponding to generation of the training email, invocation of link(s) contained in the training email, forwarding of the training email to the email address specified in the instructions for handling phishing emails, or the like). Additionally or alternatively, report 600 may include an indication of the difficultly level associated with the training email(s) and/or the number of phishing characteristics included in the training email(s). Returning to FIG. 4F, at step 37, computing platform 308 may communicate (e.g., via communication interface 316) the phishing-training report (e.g., report 600) to user device 306.

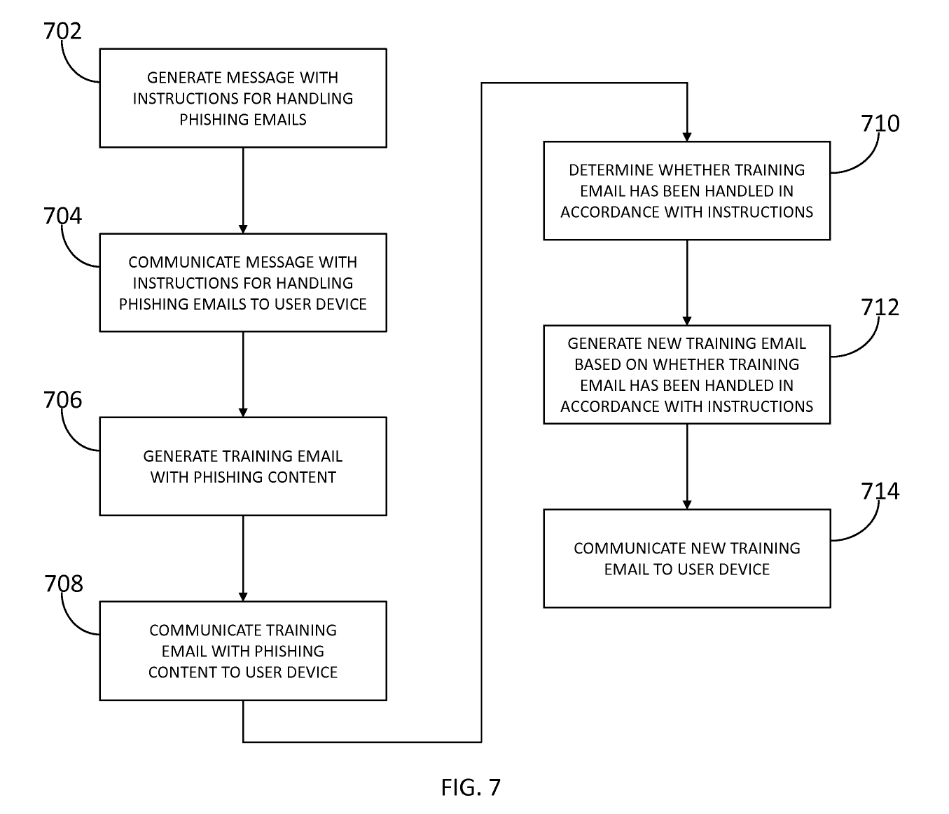

FIG. 7 depicts an illustrative method for automated phishing-email training in accordance with one or more example embodiments. Referring to FIG. 7, at step 702, a message comprising instructions for handling phishing emails may be generated. For example, computing platform 308 may generate a message that includes instructions for identifying phishing emails, and/or that instructs users not to invoke links contained in emails that are suspected to be phishing emails and/or to forward suspected phishing emails to a specified email address. At step 704, the message comprising instructions for handling phishing emails may be communicated to a user device. For example, computing platform 308 may communicate the message that includes instructions for identifying phishing emails, and/or that instructs users not to invoke links contained in emails that are suspected to be phishing emails and/or to forward suspected phishing emails to a specified email address to user device 302. At step 706, a training email comprising phishing content may be generated. For example, computing platform 308 may generate an email designed to resemble an actual phishing email, but intended for training purposes. At step 708, the training email comprising phishing content may be communicated to the user device. For example, computing platform 308 may communicate the email designed to resemble an actual phishing email, but intended for training purposes, to user device 302. At step 710, a determination may be made regarding whether the training email comprising phishing content has been handled in accordance with the instructions for handling phishing emails. For example, computing platform 308 may determine whether one or more links included in the email designed to resemble an actual phishing email, but intended for training purposes, have been invoked, and/or whether the email designed to resemble an actual phishing email, but intended for training purposes, has been forwarded to the specified email address. At step 712, a new training email comprising different phishing content may be generated based on whether the training email comprising phishing content has been handled in accordance with the instructions for handling phishing emails. For example, if computing platform 308 determines that the training email has been handled in accordance with the instructions for handling phishing emails, computing platform 308 may generate a new training email comprising fewer phishing characteristics than the training email (e.g., a training email that is more difficult to identify as a phishing email than the previous training email). Alternatively, if computing platform 308 determines that the training email has not been handled in accordance with the instructions for handling phishing emails, computing platform 308 may generate a new training email comprising more phishing characteristics than the training email (e.g., a training email that is easier to identify as a phishing email than the previous training email). At step 714, the new training email comprising different phishing content may be communicated to the user device. For example, computing platform 308 may communicate the new training email comprising fewer or more phishing characteristics than the previous training email to user device 302.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
at a computing platform comprising at least one processor, a memory, and a communication interface:
generating, by the at least one processor, a message comprising instructions for handling phishing emails;
communicating, to a user device and via the communication interface, the message comprising instructions for handling phishing emails;
generating, by the at least one processor, a training email comprising phishing content;
communicating, to the user device and via the communication interface, the training email comprising phishing content;
determining, by the at least one processor, whether the training email comprising phishing content has been handled in accordance with the instructions for handling phishing emails;
generating, by the at least one processor and based on whether the training email comprising phishing content has been handled in accordance with the instructions for handling phishing emails, a new training email comprising different phishing content; and
communicating, to the user device and via the communication interface, the new training email comprising different phishing content.

2. The method of claim 1, wherein determining whether the training email comprising phishing content has been handled in accordance with the instructions for handling phishing emails comprises determining that the training email comprising phishing content has been handled in accordance with the instructions for handling phishing emails, and wherein generating the new training email comprising different phishing content comprises generating a new training email that comprises phishing content that includes an equal or smaller number of phishing characteristics than the training email comprising phishing content.

3. The method of claim 2, wherein generating the new training email that comprises phishing content that includes an equal or smaller number of phishing characteristics than the training email comprising phishing content comprises generating a new training email that comprises phishing content that includes a number of phishing characteristics equal to a number of phishing characteristics included in the training email.

4. The method of claim 2, wherein generating the new training email that comprises phishing content that includes an equal or smaller number of phishing characteristics than the training email comprising phishing content comprises generating a new training email that comprises phishing content that includes a smaller number of phishing characteristics than the training email.

5. The method of claim 1, wherein determining whether the training email comprising phishing content has been handled in accordance with the instructions for handling phishing emails comprises determining that the training email comprising phishing content has not been handled in accordance with the instructions for handling phishing emails, and wherein generating the new training email comprising different phishing content comprises generating a new training email that comprises phishing content that includes an equal or greater number of phishing characteristics than the training email comprising phishing content.

6. The method of claim 5, wherein generating the new training email that comprises phishing content that includes an equal or greater number of phishing characteristics than the training email comprising phishing content comprises generating a new training email that comprises phishing content that includes a number of phishing characteristics equal to a number of phishing characteristics included in the training email.

7. The method of claim 5, wherein generating the new training email that comprises phishing content that includes an equal or greater number of phishing characteristics than the training email comprising phishing content comprises generating a new training email that comprises phishing content that includes a greater number of phishing characteristics than the training email.

8. The method of claim 1, wherein generating the message comprising instructions for handling phishing emails comprises generating a message comprising instructions for identifying a phishing email and instructions to not invoke links contained in a phishing email.

9. The method of claim 1, wherein the training email comprising phishing content comprises one or more links, wherein determining whether the training email comprising phishing content has been handled in accordance with the instructions for handling phishing emails comprises determining that the training email comprising phishing content has been handled in accordance with the instructions for handling phishing emails, and wherein determining that the training email comprising phishing content has been handled in accordance with the instructions for handling phishing emails comprises determining that the one or more links have not been invoked.

10. The method of claim 1, wherein the training email comprising phishing content comprises one or more links, wherein determining whether the training email comprising phishing content has been handled in accordance with the instructions for handling phishing emails comprises determining that the training email comprising phishing content has not been handled in accordance with the instructions for handling phishing emails, and wherein determining that the training email comprising phishing content has not been handled in accordance with the instructions for handling phishing emails comprises determining that at least one of the one or more links has been invoked.

11. The method of claim 10, comprising, responsive to determining that the at least one of the one or more links has been invoked:
generating, by the at least one processor, a message indicating that the training email comprising phishing content has not been handled in accordance with the instructions for handling phishing emails, comprising a depiction of the training email comprising phishing content that identifies one or more phishing characteristics of the training email comprising phishing content, and indicating that the one or more links should not have been invoked; and
communicating, to the user device and via the communication interface, the message indicating that the training email comprising phishing content has not been handled in accordance with the instructions for handling phishing emails.

12. The method of claim 1, wherein generating the message comprising instructions for handling phishing emails comprises generating a message comprising instructions for identifying a phishing email and instructions to forward a phishing email to a specified email address.

13. The method of claim 12, wherein determining whether the training email comprising phishing content has been handled in accordance with the instructions for handling phishing emails comprises determining that the training email comprising phishing content has been handled in accordance with the instructions for handling phishing emails, and wherein determining that the training email comprising phishing content has been handled in accordance with the instructions for handling phishing emails comprises determining that the training email comprising phishing content has been forwarded to the specified email address.

14. The method of claim 12, wherein determining whether the training email comprising phishing content has been handled in accordance with the instructions for handling phishing emails comprises determining that the training email comprising phishing content has not been handled in accordance with the instructions for handling phishing emails, and wherein determining that the training email comprising phishing content has not been handled in accordance with the instructions for handling phishing emails comprises determining that the training email comprising phishing content has not been forwarded to the specified email address.

15. The method of claim 14, comprising, responsive to determining that the training email comprising phishing content has not been forwarded to the specified email address:
generating, by the at least one processor, a message indicating that the training email comprising phishing content has not been handled in accordance with the instructions for handling phishing emails, comprising a depiction of the training email comprising phishing content that identifies one or more phishing characteristics of the training email comprising phishing content, and indicating that the training email comprising phishing content should have been forwarded to the specified email address; and
communicating, to the user device and via the communication interface, the message indicating that the training email comprising phishing content has not been handled in accordance with the instructions for handling phishing emails.

16. The method of claim 1, comprising:
communicating, to a different user device and via the communication interface, the message comprising instructions for handling phishing emails;
generating, by the at least one processor, another training email comprising phishing content;
communicating, to the different user device and via the communication interface, the another training email comprising phishing content;
determining, by the at least one processor, whether the another training email comprising phishing content has been handled in accordance with the instructions for handling phishing emails;
generating, by the at least one processor and based on whether the another training email comprising phishing content has been handled in accordance with the instructions for handling phishing emails, a different new training email comprising different phishing content; and
communicating, to the different user device and via the communication interface, the different new training email comprising different phishing content.

17. The method of claim 16, comprising:
determining, by the at least one processor, whether the new training email comprising different phishing content has been handled in accordance with the instructions for handling phishing emails;
determining, by the at least one processor, whether the different new training email comprising different phishing content has been handled in accordance with the instructions for handling phishing emails;
generating, by the at least one processor, a record for a user associated with the user device and comprising information indicating whether the training email comprising phishing content has been handled in accordance with the instructions for handling phishing emails and whether the new training email comprising different phishing content has been handled in accordance with the instructions for handling phishing emails;
generating, by the at least one processor, a record for a user associated with the different user device and comprising information indicating whether the another training email comprising phishing content has been handled in accordance with the instructions for handling phishing emails and whether the different new training email comprising different phishing content has been handled in accordance with the instructions for handling phishing emails;
storing, in the memory, the record for the user associated with the user device and comprising information indicating whether the training email comprising phishing content has been handled in accordance with the instructions for handling phishing emails and whether the new training email comprising different phishing content has been handled in accordance with the instructions for handling phishing emails; and
storing, in the memory, the record for the user associated with the different user device and comprising information indicating whether the another training email comprising phishing content has been handled in accordance with the instructions for handling phishing emails and whether the different new training email comprising different phishing content has been handled in accordance with the instructions for handling phishing emails.

18. The method of claim 17, comprising:
utilizing, by the at least one processor, the information indicating whether the training email comprising phishing content has been handled in accordance with the instructions for handling phishing emails and whether the new training email comprising different phishing content has been handled in accordance with the instructions for handling phishing emails, and the information indicating whether the another training email comprising phishing content has been handled in accordance with the instructions for handling phishing emails and whether the different new training email comprising different phishing content has been handled in accordance with the instructions for handling phishing emails, to generate a report indicating whether the training email comprising phishing content has been handled in accordance with the instructions for handling phishing emails, whether the new training email comprising different phishing content has been handled in accordance with the instructions for handling phishing emails, whether the another training email comprising phishing content has been handled in accordance with the instructions for handling phishing emails, and whether the different new training email comprising different phishing content has been handled in accordance with the instructions for handling phishing emails; and
communicating, to a user device associated with an administrator of the computing platform, the report indicating whether the training email comprising phishing content has been handled in accordance with the instructions for handling phishing emails, whether the new training email comprising different phishing content has been handled in accordance with the instructions for handling phishing emails, whether the another training email comprising phishing content has been handled in accordance with the instructions for handling phishing emails, and whether the different new training email comprising different phishing content has been handled in accordance with the instructions for handling phishing emails.

19. An apparatus, comprising:
at least one processor; and
a memory storing instructions that when executed by the at least one processor cause the apparatus to:
determine whether a training email comprising phishing characteristics has been handled in accordance with instructions for handling phishing emails;
responsive to determining that the training email comprising phishing characteristics has been handled in accordance with the instructions for handling phishing emails, generate a new training email comprising fewer phishing characteristics than the training email; and
responsive to determining that the training email comprising phishing characteristics has not been handled in accordance with the instructions for handling phishing emails, generate a new training email comprising more phishing characteristics than the training email.

20. One or more non-transitory computer-readable media having instructions stored thereon that when executed by one or more computers cause the one or more computers to:
determine whether a training email comprising phishing content has been handled in accordance with instructions for handling phishing emails; and
generate, based on whether the training email comprising phishing content has been handled in accordance with the instructions for handling phishing emails, a new training email comprising different phishing content.
